(19) United States
(12) Patent Application Publication
(10) Pub. No.: US 2014/0113708 A1
(43) Pub. Date: Apr. 24, 2014

(54) SYSTEM FOR PROVIDING GAME APPLYING CONCEPT OF EXCHANGE RATE, TERMINAL THEREFOR, SERVICE DEVICE AND RECORDING MEDIUM HAVING PROGRAM RECORDED THEREON

(71) Applicants: Kyong Hoon Lee, Seoul (KR); Eun Bok Lee, Seoul (KR); Jun Yong Jung, Seoul (KR)

(72) Inventors: Kyong Hoon Lee, Seoul (KR); Eun Bok Lee, Seoul (KR); Jun Yong Jung, Seoul (KR)

(73) Assignee: SK Planet Co., Ltd., Seoul (KR)

(21) Appl. No.: 14/125,183

(22) PCT Filed: Apr. 24, 2012
(86) PCT No.: PCT/KR2012/003138

§ 371 Date: Dec. 10, 2013

(30) Foreign Application Priority Data
Jun. 10, 2011 (KR) 10-2011-0056212

(51) Int. Cl. G06Q 20/06; A63F 13/00

(52) U.S. Cl. CPC G06Q 20/065; A63F 13/00
USPC 463/25

(57) ABSTRACT

The game providing terminal applies the concept of an exchange rate, a method for providing a game thereof, a system therefor, a service device therefor, and a recording medium having a program recorded thereon that runs the same, wherein item purchasing or exchanging is carried out by setting currencies and exchange rates to be different according to each piece of game information within a game.

### TECHNICAL FIELD

The present invention relates to a game providing method and system based on a network, and more specifically, to a game providing system using a concept of an exchange rate, and a service device therefor, a terminal and a recording medium having a program recorded thereon in which a different weight of an item used in a game is set for each piece of game information and the item is traded according to the set weight.

### BACKGROUND ART

With the development of information society with communication technology and digital technology, the Internet has become an important and essential medium in all sectors including society, culture and economy. In particular, as communication networks such as the Internet are developed, online games on a network are activated, and various types of online games are supported by various devices such as computers, mobile phones or portable game devices.

In an online game, since active thinking is caused such as a user making and resolving a certain situation by himself or herself, and the game is performed among a number of participants rather than one person, the number of users are being rapidly increased, unlike a stand-alone game.

Such online games include a server-based online game in which a game server provides game content to a number of terminals and controls game execution, and a P2P based online game in which terminals of users are directly connected to one another to perform the game. Recently, a scheme which is a combination of a server scheme and a P2P scheme has been used.

In recent years, a massive multiplayer online role playing game (MMORPG) which enables all of several players, sometimes, tens of players to enjoy game together in the same virtual space is activated and content thereof is diversified.

In particular, in recent games, in order to satisfy needs of several users, a variety of characters and species are provided such that the user selects a desired character or species to progress the game, and a variety of items or objects are allowed to be acquired, purchased, and exchanged during game progress in order to increase users' interests.

### DISCLOSURE

### Technical Problem

An object of the present invention is to provide a game providing system using a concept of an exchange rate, a service device therefor, a terminal, and a recording medium having a program recorded thereon in which in execution of a game operating based on various species or guilds, different currencies are set according characteristics of the guilds or species for respective guilds or species, and items can be purchased or exchanged by applying an exchange rate between different currencies.

### Technical Solution

A system for providing a game using a concept of an exchange rate according to an embodiment of the present invention to accomplish the object as described above includes a terminal which transmits game information selected by a user during game execution to a service device, transmits information for a requested item to the service device when there is a request for purchase or exchange of at least one item used for the game, receives cost information for the purchase or exchange of the requested item from the service device, and executes payment according to the received cost information; and the service device which receives the game information for at least one game from the terminal, confirms the received game information to set a different currency for each piece of game information, determines an exchange rate corresponding to the set currency, applies the determined currency and exchange rate to the requested item when there is the request for purchase or exchange for the at least one item, transmits the cost information of the item to which the currency and the exchange rate have been applied to the terminal, and executes payment for the cost information.

A terminal for providing a game using a concept of an exchange rate according to an embodiment of the present invention includes a terminal communication unit which transmits and receives data according to game execution to and from the outside; a terminal storage unit which stores game information generated according to the game execution; and a terminal control unit functionally connected to the terminal communication unit and the terminal storage unit, wherein the terminal control unit performs control to transmit game information selected by a user during the game execution to a service device, transmit information for a requested item to the service device when there is a request for purchase or exchange of at least one item used for the game, receive cost information for the purchase or exchange of the items from the service device, and execute payment according to the received cost information.

Further, in the terminal according to the present invention, the terminal control unit further includes a currency setting module which sets a different currency for each piece of game information; and an exchange rate setting module which determines an exchange rate corresponding to the set currency.

Further, in the terminal according to the present invention, when purchase or exchange for the at least one item is requested, the terminal control unit applies the currency and the exchange rate to the item.

Further, in the terminal according to the present invention, the game information includes attributes corresponding to at least one of species, groups and guilds used for the game.

Further, in the terminal according to the present invention, when purchase of the item is requested, the terminal control unit confirms a currency for the game information and pays a cost of the item based on the confirmed currency.

Further, in the terminal according to the present invention, when exchange of the items is requested, the terminal control unit confirms a currency for the game information, compares weights of the items based on the confirmed currency, and pays a cost of the items according to the comparison result.

A service device for providing a game using a concept of an exchange rate according to an embodiment of the present invention includes a service communication unit which transmits and receives data according to game execution to and from at least one terminal; a service storage unit which stores game information received from the terminal; a service control unit functionally connected with the service communication unit and the service storage unit, wherein the service control unit performs control to receive the game information for at least one game from the terminal, the received game information to set a different currency for each piece of game information, determine an exchange rate corresponding to the set currency, apply the determined currency and exchange rate to a requested item when there is a request for purchase or exchange for the at least one item, transmit cost information of the item to which the currency and the exchange rate have been applied to the terminal, and execute payment for the cost information.

Further, in the service device according to the present invention, the service communication unit, the service storage unit or the service control unit is implemented by one or more servers operating based on cloud computing.

As another means for accomplishing the object of the present invention, there is provided a computer-readable recording medium having a program recorded thereon, the program causing a computer to execute: setting a different currency for each piece of game information in a game and determining an exchange rate between the set currencies; applying the determined currency and exchange rate to at least one item when purchase or exchange for the at least one item is requested; monitoring an action score for each piece of game information corresponding to at least one of species, groups and guilds used for the game during game execution; storing the monitored action score and reflecting the stored action score on the exchange rate to readjust the exchange rate; setting a weight of the item for each piece of game information according to an acquisition status of the item and a use frequency of the item for each piece of game information; and executing cost payment for the item according to the applied currency and exchange rate.

### Advantageous Effects

According to the present invention, currencies are set with different weights according to attributes of game information in a game with species and guilds having various characteristics, and an exchange rate between different currencies is applied for purchase and exchange of an item, such that the game can be enjoyed with a different feeling from existing one.

Further, there are excellent effects in that inequality caused by a difference between the characteristics of species and guilds can be overcome by applying different currencies and exchange rates, and a concept of the currencies and the exchange rates can be learned through the game.

### DESCRIPTION OF DRAWINGS

FIG. 1 is a configuration diagram illustrating a game providing system to which a concept of an exchange rate is applied according to an embodiment of the present invention.

FIG. 2 is a block diagram illustrating a configuration of a terminal according to an embodiment of the present invention.

FIG. 3 is a block diagram illustrating a configuration of a service device according to an embodiment of the present invention.

FIG. 4 is a flowchart illustrating operation of a terminal according to an embodiment of the present invention.

FIG. 5 is a flowchart illustrating operation of a service device according to an embodiment of the present invention.

FIG. 6 is a data flow diagram illustrating a game providing method to which a concept of an exchange rate is applied according to an embodiment of the present invention.

FIGS. 7A to 7D are illustrative diagrams illustrating a game providing method to which a concept of an exchange rate is applied according to an embodiment of the present invention.

### MODE FOR INVENTION

Hereinafter, preferred embodiments of the present invention will be described in detail with reference to the accompanying drawings. However, a detailed description of known functions or configuration making the gist of the present invention ambiguous in the following description and the accompanying drawings is omitted. Further, it is to be noted that the same components are denoted with the same reference numbers in the all drawings, if possible.

Terminologies or words used in this disclosure and claims described hereinafter should not be construed as ordinary or dictionary meanings, and should be construed as meanings and concepts according to the technical spirit of the present invention based on a principle that an inventor can appropriately define concepts of terminologies in order to explain his or her invention with the best method. Accordingly, embodiments described in this disclosure and configurations shown in the drawings are only the most preferred embodiments of the present invention and do not represent an entire technical sprit of the present invention, and thus, it should be understood that there may be various equivalents and variants at the time of filing.

Hereinafter, a terminal according to an embodiment of the present invention will be described in which a representative example thereof is a mobile communication terminal connected to a communication network and being capable of executing an online game and exchanging or purchasing items in association with game information during game execution, but the terminal is not limited to the mobile communication terminal and may be any terminal such as an information communication device, a multimedia terminal, a wired terminal, a stationary terminal, and an Internet protocol (IP) terminal. Further, the terminal may be advantageously used when the terminal is a mobile terminal having various mobile communication specifications such as a mobile phone, a portable multimedia player (PMP), a mobile Internet device (MID), a smart phone, a desktop PC, a tablet PC, a note book, a net book and an information communication device.

FIG. 1 is a configuration diagram illustrating a game providing system to which a concept of an exchange rate is applied according to an embodiment of the present invention.

Referring to FIG. 1, a game system 100 according to an embodiment of the present invention includes a terminal 10, a service device 20 and a communication network 30.

The communication network 30 functions to provide a path for data transmission and reception between the terminal 10 and the service device 20 in the game system 100. Here, the communication network 30 performs a series of data transmission and reception operations for data transmission and information exchange between the terminal 10 and the service device 20. The communication network 30 performing such a function is an IP network which provides massive data transmission and reception service and seamless data service through Internet protocol, and may be an All IP network having an IP network structure in which different networks are integrated based on an IP. Further, the communication network 30 may be one of a wired communication network, a mobile communication network, a wireless broadband (Wibro) network, a high speed downlink packet access (HSDPA) network, and a satellite communication network.

The terminal 10 accesses the service device 20 over the communication network 30. In particular, the terminal 10 according to an embodiment of the present invention selects game information in the game and transmits the selected game information to the service device 20. Also, the terminal 10 requests purchase or exchange of a specific item during game execution and transmits information for the item to the service device 20. The terminal 10 then receives cost information for purchase or exchange of the items from the service device 20, and executes payment according to the received cost information.

The terminal 10 confirms game information in the game and sets a different currency for each piece of confirmed game information. Also, the terminal 10 determines an exchange rate between the set currencies. In this case, when the terminal 10 requests the purchase or exchange for a specific item, the terminal 10 applies the currency and the exchange rate to the item.

The service device 20 is connected to the terminal 10 over the communication network 30 and provides a game. In particular, the service device 20 according to an embodiment of the present invention receives game information from the terminal 10. Also, the service device 20 confirms the received game information to set a different currency for each piece of game information, and determines an exchange rate between the set currencies. In this case, when the purchase or exchange for a specific item is requested, the service device 20 applies the currency and the exchange rate to the item. The service device 20 then transmits cost information of the item to which the currency and the exchange rate have been applied, to the terminal 10. Also, the service device 20 communicates with the terminal 10 to execute payment for cost information.

Thus, currencies are set with different weights according to attributes of game information in a game with species and guilds having various characteristics, and an exchange rate between different currencies is applied for purchase and exchange of an item, such that the game can be enjoyed with a different feeling from existing one. Further, there are excellent effects in that inequality caused by a difference between the characteristics of species and guilds can be overcome by applying different currencies and exchange rates, and a concept of the currencies and the exchange rates can be learned through the game.

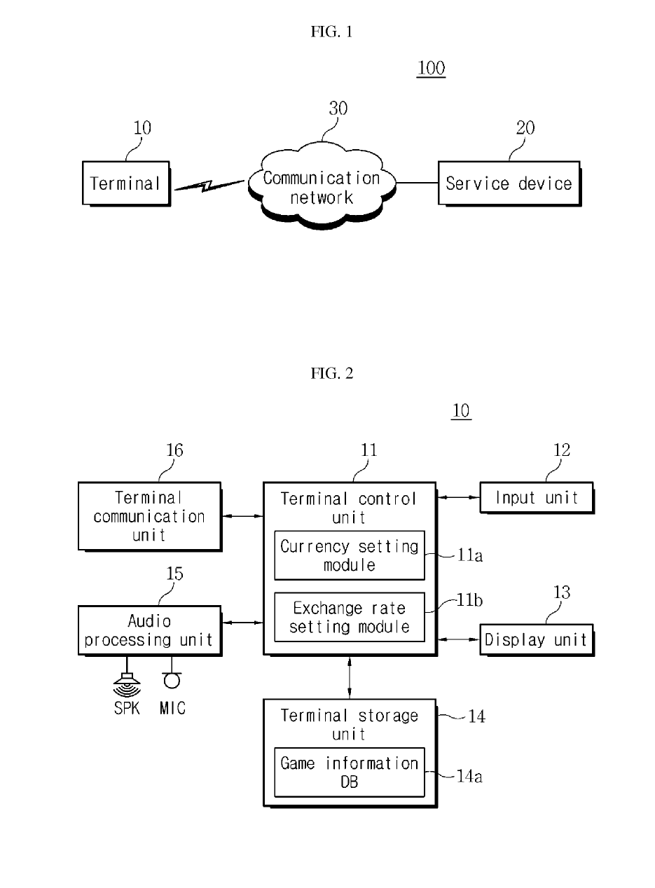

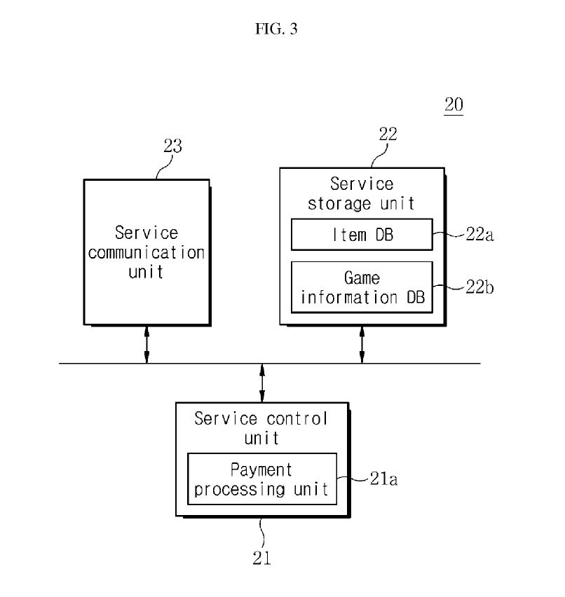

FIG. 2 is a block diagram illustrating a configuration of the terminal according to an embodiment of the present invention.

Referring to FIG. 2, the terminal 10 of the game system 100 according to an embodiment of the present invention includes a terminal control unit 11, an input unit 12, a display unit 13, a terminal storage unit 14, an audio processing unit 15 and a terminal communication unit 16 for game execution. Further, the terminal control unit 11 includes a currency setting module 11a and an exchange rate setting module 11b, and the terminal storage unit 14 includes a game information DB 14a.

The input unit 12 receives various pieces of information such as numeric and text information, and transfers a signal input in relation to various function settings and function control of the terminal 10 to the terminal control unit 11. Further, the input unit 12 may include at least one of a keypad and a touch pad which generate an input signal according to a touch or a manipulation of a user. In this case, the input unit 12 may be configured in the form of one touch panel (or a touch screen) together with the display unit 13 to be able to perform both an input function and a displaying function. Further, the input unit 12 may be any form of input means which may be developed in future, as well as an input device such as a keyboard, a keypad, a mouse, or a joystick. In particular, the input unit 12 transfers an input signal for item purchase or exchange according to a request of the user during game execution to the terminal control unit 11.

The display unit 13 displays information for a series of operation states and operation results generated during function execution of the terminal 10. Further, the display unit 13 may display menus of the terminal 10, user data input by the user, and the like. Here, the display unit 13 may be a liquid crystal display (LCD), a thin film transistor LCD (TFT-LCD), an organic light emitting diode (OLED), a light emitting diode (LED), an active matrix organic LED (AMOLED), a flexible display, or a three-dimensional display. In this case, the display unit 13 may be configured in the form of a touch screen. When the display unit 13 is configured in the form of a touch screen in this way, the display unit 13 may perform some or all of functions of the input unit 12. In particular, the display unit 13 according to an embodiment of the present invention displays a progress screen according to the game execution, a progress screen for item purchase or exchange, and the like.

The terminal storage unit 14 is a device for storing data, includes a main storage device and a subsidiary storage device, and stores an application program necessary for a functional operation of the terminal 10. This terminal storage unit 14 may greatly include a program area and a data area. Here, when the terminal 10 activates each function in response to a request of the user, the terminal 10 executes an application program to provide each function under control of the terminal control unit 11. In particular, the program area according to an embodiment of the present invention stores an operating system which boots the terminal 10, a program which executes a game, a program which applies a currency or an exchange rate for each piece of game information, a program which executes purchase or exchange of items, and the like. Further, the data area is an area in which data generated according to use of the terminal 10 is stored. In particular, the data area according to an embodiment of the present invention stores game information generated according to game execution, data in which different currencies and exchange rates are applied for each piece of game information, and the like. Here, the data area stores attributes of the game information corresponding to the species, the guilds or the groups in the game information DB 14a.

The audio processing unit 15 performs a function of reproducing and outputting an audio signal through a speaker (SPK) or transferring an audio signal input from a microphone (MIC) to the terminal control unit 11. This audio processing unit 15 may convert an audio signal of an analog format input through the microphone into an audio signal of a digital format, and transfer the audio signal to the terminal control unit 11. The audio processing unit 15 may also convert an audio signal of a digital format output from the terminal control unit 11 to an analog signal and output the analog signal through the speaker. In particular, the audio processing unit 15 outputs audio data generated according to the game execution.

The terminal communication unit 16 performs a function of transmitting and receiving data to and from the service device 20 over the communication network 30. Here, the terminal communication unit 16 includes an RF transmission means which up-converts a frequency of a transmitted signal and amplifies the signal, and an RF reception means which low-noise amplifies a received signal and down-converts a frequency of the signal. This terminal communication unit 16 may include at least one of a wireless communication module (not shown) and a wired communication module (not shown). Also, the wireless communication module may include at least one of a wireless network communication module, a wireless local area network (WLAN), Wireless Fidelity (WiFi) or worldwide interoperability for microwave access (WiMAX)) communication module, and a wireless personal area network (WPAN) communication module.

The wireless communication module has a configuration for transmitting and receiving data according to a wireless communication method. When the terminal 10 uses wireless communication, the terminal 10 may transmit or receive data to or from the service device 20 using any one of the wireless network communication module, the WLAN communication module and the WPAN communication module.

The wireless network communication module is intended to access the communication network 30 to transmit and receive data via a base station. When the wireless communication module receives data from the terminal control unit 11, the wireless communication module may access the communication network 30 to transmit data to the service device 20 via the base station. Further, the wireless network communication module may access the communication network 30 via the base station to receive data from the service device 20 and provide the received data to the terminal control unit 11.

The WLAN communication module is intended to perform communication according to a wireless LAN (WLAN), WiFi or WiMAX scheme. When the WLAN communication module receives data from the terminal control unit 11, the WLAN communication module may access the communication network 30 via an access point (AP) to transmit data to the service device 20. Further, when the WLAN communication module accesses the communication network 30 via the access point and receives data from the service device 20, the WLAN communication module may provide the received data to the terminal control unit 11.

The WPAN communication module is intended to transmit and receive data according to a wireless PAN (WPAN) scheme, and performs wireless communication of a shorter distance than the wireless network communication module and the WLAN communication module. The WPAN communication module enables terminals to directly transmit and receive data therebetween. That is, direct data transmission and reception to or from another terminal may be performed via the WPAN communication module. Further, when the WPAN communication module can be connected to a gateway in the communication network 30 directly or through a multi-hop, the WPAN communication module may access the communication network 30 via the gateway to transmit and receive data. This WPAN communication module may perform communication according to Bluetooth, IrDA, ZigBee or the like.

The wired communication module is intended to transmit and receive data in a wired manner. The wired communication module may access the communication network 30 in a wired manner to transmit or receive data to or from the service device 20. That is, the terminal 10 may access the communication network 30 using the wired communication module to transmit or receive data to or from the service device 20. In particular, the terminal communication unit 16 according to an embodiment of the present invention transmits game information according to the game execution to the service device 20, and transmits information for an item according to exchange or purchase of a specific item to the service device 20. Further, the terminal communication unit 16 receives cost information for an item for which the purchase or exchange has been requested from the service device 20.

The terminal control unit 11 may be an operating system (OS), and a processing device which drives each component.

The terminal control unit 11 controls overall operation of the terminal 10, and is functionally connected with each component of the terminal 10. For example, the terminal control unit 11 may be a central processing unit (CPU). When the terminal 10 is powered on, the terminal control unit 11 moves the operating system from a subsidiary storage device to a main storage device, performs booting for driving the operating system, and performs necessary signal control. In particular, the terminal control unit 11 according to an embodiment of the present invention selects game information in the game and transmits the selected game information to the service device 20. Here, the game information includes attributes such as species, groups and guilds used through the game.

The terminal control unit 11 requests purchase or exchange of a specific item during game execution, and transmits information for the item to the service device 20. The terminal control unit 11 then receives cost information for purchase or exchange of the items from the service device 20, and executes payment according to the received cost information.

The terminal control unit 11 confirms the game information in the game, and sets a different currency for each pieces of confirmed game information. Also, the terminal control unit 11 determines an exchange rate corresponding to the set currency for each piece of game information. Then, when purchase or exchange for a specific item is requested, the terminal control unit 11 applies the currency and the exchange rate to the item.

The terminal control unit 11 monitors an action score for each piece of game information during the game execution, and stores the monitored action score. Also, the terminal control unit 11 reflects the stored action score on the exchange rate to adjust the exchange rate. Then, the terminal control unit 11 may set a weight of the item for each piece of game information according to an acquisition status of the item and a use frequency of the item for each piece of game information.

The terminal 10 according to an embodiment of the present invention further includes the currency setting module 11a and the exchange rate setting module 11b in order to more effectively provide the game by applying the concept of the exchange rate. In particular, the currency setting module 11a sets a different currency for each piece of game information, and the exchange rate setting module 11b determines the exchange rate between the currencies set by the currency setting module 11a.

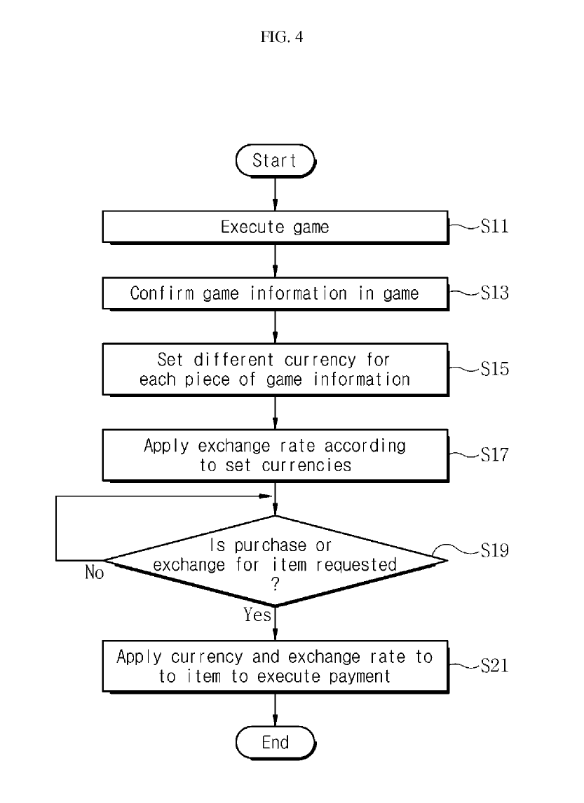

FIG. 3 is a block diagram illustrating a configuration of the service device according to an embodiment of the present invention.

Referring to FIG. 3, the service device 20 according to an embodiment of the present invention includes a service control unit 21, a service storage unit 22, and a service communication unit 23. Here, the service control unit 21 includes a payment processing unit 21a, and the service storage unit 22 includes an item DB 22a and a game information DB 22b.

Each component of the service device 20 is functionally connected in order to perform operation of the present invention.

The service communication unit 23 communicates with the terminal 10 to transmit and receive data according to game execution.

The service storage unit 22 stores the game information received from the terminal 10. In particular, the service storage unit 22 stores various items used in the game in the item DB 22a. In this case, for the items stored in the item DB 22a, weights may be set according to various exchange rates and currencies, and the items may be divided according to the set weights and stored. Further, the game information DB 22b stores various pieces of information including attributes such as species, groups and guilds used through the game.

The service control unit 21 performs a function of controlling a series of operations of the service device 20. In particular, the service control unit 21 according to the present invention confirms the game information received from the terminal 10 to set a different currency for each piece of game information and determine an exchange rate corresponding to the set currency. In this case, when purchase or exchange for a specific item is requested, the service control unit 21 applies the currency and the exchange rate to the item. Also, the service control unit 21 transmits, to the terminal 10, cost information of the item to which the currency and the exchange rate have been applied.

The service device 20 according to the present invention may be implemented by one or more servers operating in a server-based computing scheme or a cloud computing scheme. More specifically, each of the service control unit 21, the service storage unit 22 and the service communication unit 23 may be implemented by one or more independent servers or may be implemented by a plurality of servers each including the service control unit 21, the service storage unit 22 and the service communication unit 23. In addition, this service device 20 may provide the game service according to the present invention to the terminal 10 in the cloud computing scheme.

The cloud computing refers to technology for servicing IT resources virtualized by utilizing Internet technology, such as hardware (e.g., a server, a storage, and a network), software (e.g., database, security, and web server), service, data and the like in an on demand scheme, as described above. Accordingly, the service device 20 may provide the terminal 10 with the computing resources including one or more of the hardware, the software, the service, and the data necessary for providing the game service according to the present invention. For example, the service device 20 may provide a virtual computing space where a game is executed to the terminal 10 so that the game is executed through the computing space. Further, the game providing device 20 may provide a storage space in which game data and game software are stored, and perform the above-described functions through the storage space. Further, the service device 20 may store game software and provide the game software to the terminal 10 or execute the game software to provide an execution result to the terminal 10 in response to a request of the terminal 10.

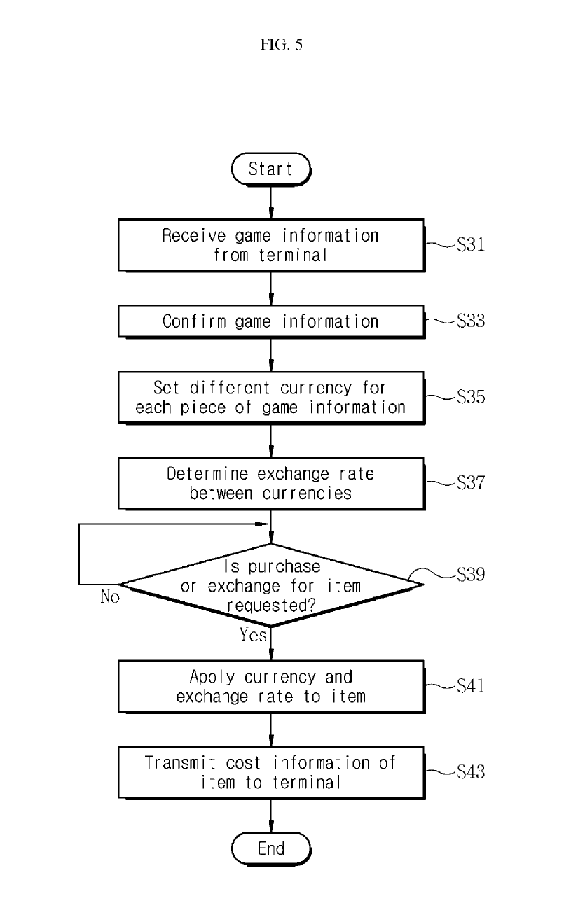

FIG. 4 is a flowchart illustrating operation of the terminal according to an embodiment of the present invention.

Referring to FIG. 4, the terminal 10 according to an embodiment of the present invention executes a game in operation S11. The terminal 10 then confirms game information in the game in operation S13. Here, the game information includes attributes such as species, groups and guilds used through the game.

The terminal 10 sets a different currency for each piece of game information in operation S15. That is, the terminal 10 applies a different currency according to the same species or group and guild. Also, the terminal 10 determines an exchange rate between the currencies set for the respective pieces of game information in operation S17. For example, the terminal 10 may also determine an exchange rate for a species whose number of uses of users is great to be lower than an exchange rate for a species whose number of uses is small. Further, the terminal 10 may determine an exchange rate for a guild or group to which more users have subscribed to be higher than an exchange rate for a guild or group to which less users have subscribed.

The terminal 10 then confirms whether purchase or exchange for a specific item is requested in operation S19. In this case, when the purchase or exchange for a specific item is requested, the terminal 10 applies the currency and the exchange rate to the item to execute payment in operation S21. On the other hand, when the purchase or exchange for a specific item is not requested, the terminal 10 continuously confirms whether the purchase or exchange for at least one item is requested while executing the game.

The terminal 10 according to an embodiment of the present invention monitors an action score for each piece of game information during the game execution, and stores the monitored action score. Also, the terminal 10 reflects the stored action score on the exchange rate to adjust the exchange rate. The terminal 10 then sets a weight of the item for each piece of game information according to an acquisition status of the item and a use frequency of the item for each piece of game information.

Thus, currencies are set with different weights according to attributes of game information in a game with species and guilds having various characteristics, and an exchange rate between different currencies is applied for purchase and exchange of an item, such that the game can be enjoyed with a different feeling from existing one. Further, there are excellent effects in that inequality caused by a difference between the characteristics of species and guilds can be overcome by applying different currencies and exchange rates, and the concept of the currencies and the exchange rates can be learned through the game.

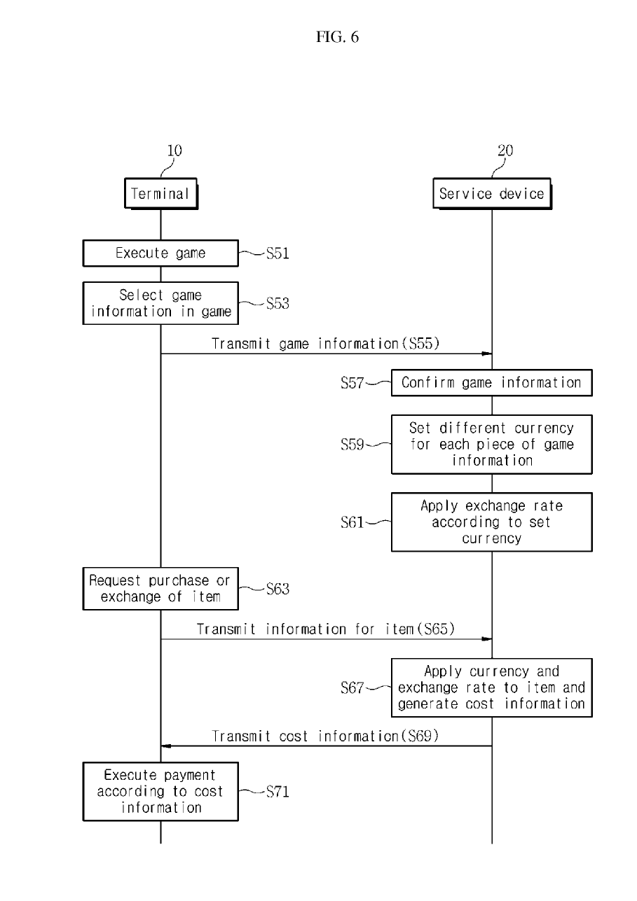

FIG. 5 is a flowchart illustrating operation of the service device according to an embodiment of the present invention.

Referring to FIG. 5, the service device 20 according to an embodiment of the present invention receives game information from the terminal 10 in operation S31. In this case, the game information includes attributes such as species, groups and guilds used by the user through the game. When the game information is received, the service device 20 confirms the game information in operation S33.

The service device 20 sets a different currency for each piece of game information in operation S35. That is, the service device 20 confirms the game information in order to apply a different currency according to the same species or group and guild. The service device 20 then determines the exchange rate corresponding to the set currency in operation S37.

The service device 20 confirms whether purchase or exchange for a specific item is requested from at least one user in operation S39. Here, when purchase or exchange for a specific item is requested, the service device 20 applies the currency and the exchange rate to the item in operation S41. Also, the service device 20 transmits cost information of the item to which the currency and the exchange rate have been applied to the terminal 10 in operation S43.

On the other hand, when the purchase or exchange for a specific item is not requested, the service device 20 continuously confirms whether the user requests purchase or exchange for at least one item while executing the game.

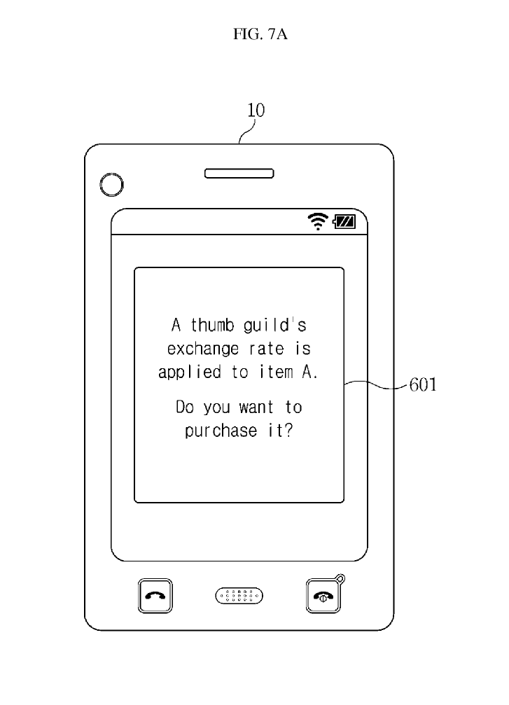

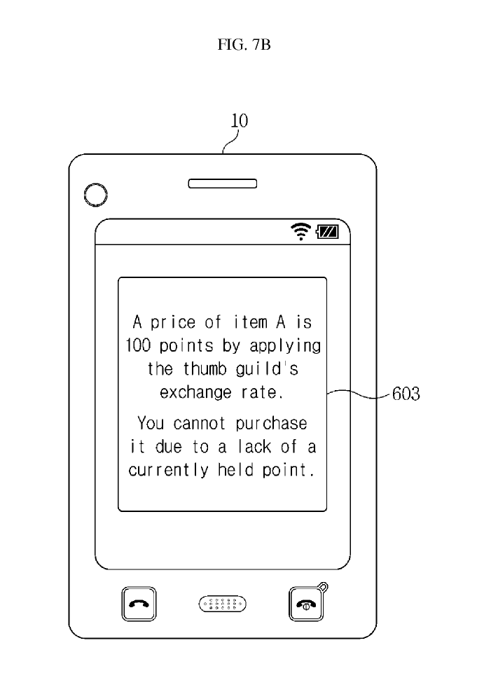

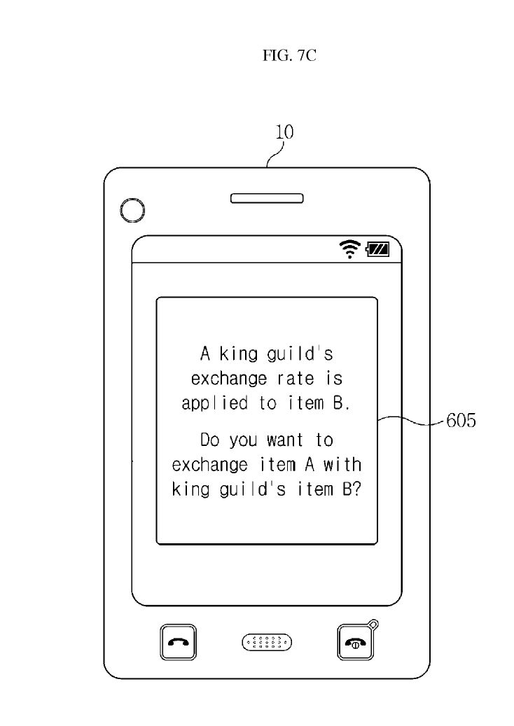

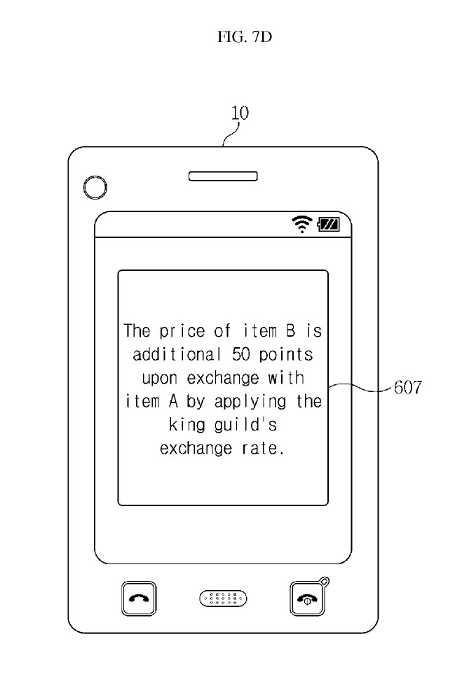

FIG. 6 is a data flow diagram illustrating a game providing method to which a concept of an exchange rate is applied according to an embodiment of the present invention, and FIGS. 7A to 7D are illustrative diagrams illustrating a game providing method to which a concept of an exchange rate is applied according to an embodiment of the present invention.

Referring to FIG. 6, in the game providing method to which a concept of an exchange rate is applied according to an embodiment of the present invention, first, the terminal 10 executes a game in operation S51. In this case, the terminal 10 requests the service device 20 to execute the game, and progresses the game through data according to the game execution received from the service device 20.

The terminal 10 selects game information in the game in operation S53. Also, the terminal 10 transmits the selected game information to the service device 20. Here, the game information includes attributes such as species, groups and guilds used through the game.

The service device 20 confirms the game information received from the terminal 10 in operation S57. Here, the service device 20 sets a different currency for each piece of game information in operation S59. Further, the service device 20 determines and applies an exchange rate corresponding to the set currency in operation S61.

The terminal 10 requests purchase or exchange of a specific item during game execution in operation S63. Also, the terminal 10 transmits information for the item to the service device 20 in operation S65. Then, when the purchase or exchange for a specific item is requested, the service device 20 applies the currency and the exchange rate to the item in operation S67.

If the currency and the exchange rate are applied, the service device 20 transmits cost information of the item to which the currency and the exchange rate have been applied to the terminal 10 in operation S69. The terminal 10 then receives the cost information for the purchase or exchange of the items from the service device 20 and executes payment according to the received cost information in operation S71.

In a method of applying a currency and an exchange rate for each piece of game information for purchase or exchange of a specific item during game execution according to an embodiment of the present invention, the terminal 10 communicates with the service device 20 to provide a game or the terminal 10 itself is used to provide the game.

As illustrated in FIG. 7A, when a request signal for purchase of a specific item is received from the user, the terminal 10 displays a pop-up message 601. For example, the terminal 10 presents a message “A thumb guild's exchange rate is applied to item A. Do you want to purchase it?” Also, as illustrated in FIG. 7B, the terminal 10 confirms the currency and the exchange rate according to the game information to display a pop-up message 603 in response to an agreement signal of the user. For example, the terminal 10 presents a message “A price of item A is 100 points by applying the thumb guild's exchange rate. You cannot purchase it due to a lack of a currently held point.”

As illustrated in FIG. 7C, when the request signal for exchange of a specific item is received from the user, the terminal 10 displays a pop-up message 605. For example, the terminal 10 presents a message “A king guild's exchange rate is applied to item B. Do you want to exchange item A with king guild's item B?” Also, as illustrated in FIG. 7D, the terminal 10 compares weights of items to be exchanged based on the currency for the game information in response to the agreement signal of the user and displays a pop-up message 607 for an item exchange cost according to a comparison result. For example, the terminal 10 presents a message “The price of item B is additional 50 points upon exchange with item A by applying the king guild's exchange rate.”

The game providing method to which a concept of an exchange rate is applied according to the present invention may be implemented in the form of software which is readable through various computer means and recorded on a computer-readable recording medium. A program recorded on the computer-readable recording medium and executed by a computer according to the present invention is implemented to include operations of: setting a different currency for each piece of game information in a game and determining an exchange rate between the set currencies, applying the determined currency and exchange rate to at least one item when purchase or exchange for the at least one item is requested, monitoring an action score for each piece of game information corresponding to at least one of species, groups and guilds used for the game during game execution, storing the monitored action score and reflecting the stored action score on the exchange rate to readjust the exchange rate, setting a weight of the item for each piece of game information according to an acquisition status of the item and a use frequency of the item for each piece of game information, and executing cost payment for the item according to the applied currency and exchange rate.

The program including such operations is executed by the computer, sets a different currency for each piece of game information in a game and determines an exchange rate between the set currencies. The program applies the determined currency and exchange rate to at least one item when purchase or exchange for the at least one item is requested. In addition, the program monitors an action score for each piece of game information corresponding to at least one of species, groups and guilds used for the game during game execution, stores the monitored action score, and reflects the stored action score on the exchange rate to readjust the exchange rate. Further, the program sets a weight of the item for each piece of game information according to an acquisition status of the item and a use frequency of the item for each piece of game information. The program may execute cost payment for the item according to the applied currency and exchange rate.

Here, the recording medium may include program instructions, data files, data structures or the like alone or in combination. The program instructions recorded in the recording medium may be program instructions particularly designed and structured for the present invention or program instructions known and available to those skilled in the art of computer software. For example, the recording medium includes a hardware device particularly configured to store and perform a program instruction, such as a magnetic medium such as a hard disk, a floppy disk and a magnetic tape, an optical medium such as a compact disk read only memory (CD-ROM) or a digital video disk (DVD), a magneto-optical medium such as a floptical disk, a ROM, a random access memory (RAM), or a flash memory. Example of the program instruction may include a high-level language code that can be executed by a computer using an interpreter or the like, as well as machine language code created by a compiler. This hardware device may be configured to operate as one or more software modules in order to perform the operation of the present invention, and vice versa.

Meanwhile, while the embodiments of the present invention disclosed in this disclosure and the drawings are only specific examples suggested to assist in understanding the present invention, and do not intend to limit the present invention. It is apparent to those skilled in the art that other variants based on the scope and spirit of the present invention can be made, in addition to the embodiments disclosed herein.

The present invention is applied to various types of user devices such as a mobile communication terminal, a PMP, a PDA, a notebook, and an MP3 player, so that a different currency or exchange rate is set for each piece of game information in a game and the item purchase or exchange is progressed. Thus, the currencies are set with different weights according to attributes of game information in a game with species and guilds having various characteristics, and an exchange rate between different currencies is applied for purchase and exchange of an item, such that the game can be enjoyed with a different feeling from existing one. Further, there are excellent effects in that inequality caused by a difference between the characteristics of species and guilds can be overcome by applying different currencies and exchange rates, and a concept of the currencies and the exchange rates can be learned through the game.

1. A system for providing a game using a concept of an exchange rate, the system comprising:
a terminal which transmits game information selected by a user during game execution to a service device, transmits information for a requested item to the service device when there is a request for purchase or exchange of at least one item used for the game, receives cost information for the purchase or exchange of the requested item from the service device, and executes payment according to the received cost information; and
the service device which receives the game information for at least one game from the terminal, confirms the received game information to set a different currency for each piece of game information, determines an exchange rate corresponding to the set currency, applies the determined currency and exchange rate to the requested item when there is the request for purchase or exchange for the at least one item, transmits the cost information of the item to which the currency and the exchange rate have been applied to the terminal, and executes payment for the cost information.

2. A terminal for providing a game using a concept of an exchange rate, the terminal comprising:
a terminal communication unit which transmits and receives data according to game execution to and from the outside;
a terminal storage unit which stores game information generated according to the game execution; and
a terminal control unit functionally connected to the terminal communication unit and the terminal storage unit,
wherein the terminal control unit performs control to transmit game information selected by a user during the game execution to a service device, transmit information for a requested item to the service device when there is a request for purchase or exchange of at least one item used for the game, receive cost information for the purchase or exchange of the items from the service device, and execute payment according to the received cost information.

3. The terminal according to claim 2, wherein the terminal control unit further comprises:
a currency setting module which sets a different currency for each piece of game information; and
an exchange rate setting module which determines an exchange rate corresponding to the set currency.

4. The terminal according to claim 3, wherein: when purchase or exchange for the at least one item is requested, the terminal control unit applies the currency and the exchange rate to the item.

5. The terminal according to claim 2, wherein: the game information includes attributes corresponding to at least one of species, groups and guilds used for the game.

6. The terminal according to claim 2, wherein: when purchase of the item is requested, the terminal control unit confirms a currency for the game information and pays a cost of the item based on the confirmed currency.

7. The terminal according to claim 2, wherein: when exchange of the items is requested, the terminal control unit confirms a currency for the game information, compares weights of the items based on the confirmed currency, and pays a cost of the items according to the comparison result.

8. A service device for providing a game using a concept of an exchange rate, the service device comprising:
a service communication unit which transmits and receives data according to game execution to and from at least one terminal;
a service storage unit which stores game information received from the terminal;
a service control unit functionally connected with the service communication unit and the service storage unit,
wherein the service control unit performs control to receive the game information for at least one game from the terminal, the received game information to set a different currency for each piece of game information, determine an exchange rate corresponding to the set currency, apply the determined currency and exchange rate to a requested item when there is a request for purchase or exchange for the at least one item, transmit cost information of the item to which the currency and the exchange rate have been applied to the terminal, and execute payment for the cost information.

9. The service device according to claim 8, wherein the service communication unit, the service storage unit or the service control unit is implemented by one or more servers operating based on cloud computing.

10. A computer-readable recording medium having a program recorded thereon, the program causing a computer to execute:
setting a different currency for each piece of game information in a game and determining an exchange rate between the set currencies;
applying the determined currency and exchange rate to at least one item when purchase or exchange for the at least one item is requested;
monitoring an action score for each piece of game information corresponding to at least one of species, groups and guilds used for the game during game execution;
storing the monitored action score and reflecting the stored action score on the exchange rate to readjust the exchange rate;
setting a weight of the item for each piece of game information according to an acquisition status of the item and a use frequency of the item for each piece of game information; and
executing cost payment for the item according to the applied currency and exchange rate.
